(19) United States
(12) Patent Application Publication
(10) Pub. No.: US 2014/0095247 A1
(43) Pub. Date: Apr. 3, 2014

(54) SUPPLY CHAIN FINANCIAL ORCHESTRATION SYSTEM WITH CONFIGURABLE EVENTS THAT TRIGGER TASKS

(71) Applicant: Oracle International Corporation, Redwood Shores, CA (US)

(72) Inventors: Karthik NATARAJAN, Bangalore (IN); Shyam Sundar SANTHANAM, Redwood City, CA (US); Kalyana Chakravarthy DANDE, Hyderabad (IN); Nitish DAVE, Bilaspur (IN); Girish JHA, Hyderabad (IN)

(73) Assignee: Oracle International Corporation, Redwood Shores, CA (US)

(21) Appl. No.: 14/034,792

(22) Filed: Sep. 24, 2013

Related U.S. Application Data
(60) Provisional application No. 61/707,630, filed on Sep. 28, 2012.

(51) Int. Cl. G06Q 10/06

(52) U.S. Cl. CPC G06Q 10/06315
USPC 705/7.25

(57) ABSTRACT

A system is provided that processes supply chain events. The system defines a supply chain event type. The system further configures a supply chain event of the supply chain event type as a task generating event, where the task generating event indicates that one or more tasks that are defined for a supply chain financial orchestration flow are to be executed, and where the supply chain financial orchestration flow defines a trade relationship between a first entity and a second entity. The system further receives a supply chain event associated with the supply chain financial orchestration flow. The system further determines whether the supply chain event is a task generating event. The system further executes the one or more tasks that are defined for the supply chain financial orchestration flow where the supply chain event is a task generating event.

### CROSS-REFERENCE TO RELATED APPLICATIONS

This application claims priority of U.S. Provisional Patent Application Ser. No. 61/707,630, filed on Sep. 28, 2012, the subject matter of which is hereby incorporated by reference.

### FIELD

One embodiment is directed to a computer system, and more particularly, to a computer system that orchestrates supply chain financial processes.

### BACKGROUND

Large multi-national companies, or other enterprises, often operate through a number of subsidiary companies, or other legal entities, spread across the globe. These subsidiary companies can be further divided into business units or lines of businesses. The intersection of each subsidiary company and line of business (identified as a “profit center business unit”) can become a supply chain entity that engages in manufacturing, purchase, and/or sale of goods and services.

The profit center business units typically engage commercially with an external supply chain, such as a collection of suppliers and customers. They can also engage in internal trades, or internal transfers, within the subsidiary company. One example type of an internal trade is an “inter-company trade,” where a profit center business unit belonging to one subsidiary company trades with a profit center business unit belonging to another subsidiary company, at arm's length terms and conditions. Another example type of an internal trade is an “intra-company trade,” where two profit center business units belonging to the same subsidiary company trade among each other on a competitive basis.

In any supply chain flow consisting of a buy, sell or transfer of goods, the buyer and seller agree upon the event of events when the cost of carrying the goods, risk and the title of the goods are transferred from the buyer to the seller. This may be explicitly agreed upon through a contract, usually using internationally accepted commercial terms. When an event that results in title transfer of goods occurs, it is expected that the seller accounts for the cost, revenue, and receivables in his books of account, and the buyer accounts for the inventory cost and liability for payment in his books. Generally, an invoice is generated, and sent by the seller to the buyer which can become the legal document for accounting and payments.

### SUMMARY

One embodiment is a system that processes supply chain events. The system defines a supply chain event type. The system further configures a supply chain event of the supply chain event type as a task generating event, where the task generating event indicates that one or more tasks that are defined for a supply chain financial orchestration flow are to be executed, and where the supply chain financial orchestration flow defines a trade relationship between a first entity and a second entity. The system further receives a supply chain event associated with the supply chain financial orchestration flow. The system further determines whether the supply chain event is a task generating event. The system further executes the one or more tasks that are defined for the supply chain financial orchestration flow where the supply chain event is a task generating event.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates an example supply chain financial orchestration flow, according to an embodiment of the invention.

FIG. 3 illustrates a block diagram of an example architecture of a supply chain financial orchestration system, according to an embodiment of the invention.

FIG. 4 illustrates an example user interface for defining a supply chain event type, according to an embodiment of the invention.

FIG. 5 illustrates an example user interface for assigning a sequence number to a supply chain event type, according to an embodiment of the invention.

FIG. 6 illustrates an example supply chain financial orchestration flow, according to an embodiment of the invention.

FIG. 7 illustrates an example user interface for configuring a supply chain event as an ownership change event by defining a documentation and accounting rule, according to an embodiment of the invention.

FIG. 8 illustrates an example user interface for defining one or more tasks for a documentation and accounting rule, according to an embodiment of the invention.

FIG. 9 illustrates an example user interface for configuring a supply chain event as a supplier ownership change event, according to an embodiment of the invention.

FIG. 10 illustrates a block diagram of an event framework that receives and processes supply chain events, according to an embodiment of the invention.

FIG. 11 illustrates an example user interface for manually creating an ownership change event, according to an embodiment of the invention.

FIG. 12 illustrates an example user interface for managing supply chain event exceptions, according to an embodiment of the invention.

FIG. 13 illustrates a flow diagram of the functionality of a supply chain financial orchestration event module, according to an embodiment of the invention.

### DETAILED DESCRIPTION

According to an embodiment, a supply chain financial orchestration system is provided that can configure one or more supply chain events as task generating events that indicate one or more tasks to be executed by the supply chain financial orchestration system. One example of a task generating event is an ownership change event that indicates an ownership change of an item from a first entity to a second entity for an internal transaction. A supply chain event is an event that occurs in a process of execution of a supply chain financial orchestration flow. A supply chain event can be a physical event, such as a shipment of goods, a transit of goods to a named port or other destination, or a receipt of goods at a delivery location. A supply chain event can also be a non-physical event, such as a receipt or dispatch of a commercial invoice, a customs clearance at a port of entry, or a confirmation of a fulfillment of a service. As previously described, in any supply chain financial orchestration flow that involves a buy, sell, or transfer of goods, the buyer and seller agree upon the event, or events, when the cost and risk of carrying the goods, as well as the title of the goods, transfer from the buyer to the seller. When this event occurs (or these events occur), it is expected that the seller accounts for the cost, revenue, and receivables, and the buyer accounts for the inventory cost and liability for payment. Thus, the supply chain financial orchestration system can determine when a supply chain event is an ownership change event that indicates an ownership change of an item from a first entity to a second entity, and can perform one or more tasks to effectuate the ownership change in response to receiving the ownership change event. Another example of a task generating event is a documentation creation event that indicates a creation of one or more documents. Thus, the supply chain financial orchestration system can determine when a supply chain event is a documentation creation event that indicates a creation of one or more documents, and that can perform one or more tasks to create the one or more documents in response to receiving the documentation creation event.

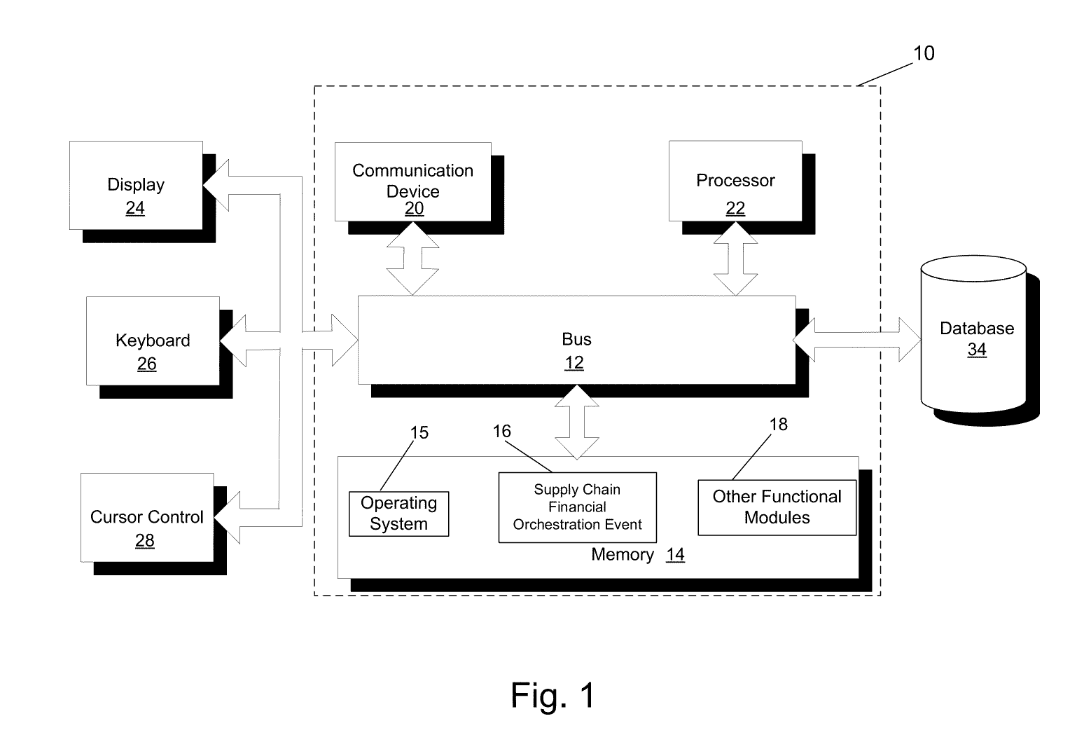

FIG. 1 illustrates a block diagram of a supply chain financial orchestration system 10 that may implement one embodiment of the invention. Supply chain financial orchestration system 10 includes a bus 12 or other communications mechanism for communicating information between components of supply chain financial orchestration system 10. Supply chain financial orchestration system 10 also includes a processor 22, operatively coupled to bus 12, for processing information and executing instructions or operations. Processor 22 may be any type of general or specific purpose processor. Supply chain financial orchestration system 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. Supply chain financial orchestration system 10 further includes a communication device 20, such as a network interface card or other communications interface, to provide access to a network. As a result, a user may interface with supply chain financial orchestration system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with supply chain financial orchestration system 10.

According to one embodiment, memory 14 can store software modules that may provide functionality when executed by processor 22. The modules can include an operating system 15, a supply chain financial orchestration event module 16, as well as other functional modules 18. Operating system 15 can provide an operating system functionality for supply chain financial orchestration system 10. Supply chain financial orchestration event module 16 can provide functionality for processing supply chain events as is described in more detail below. In certain embodiments, supply chain financial orchestration event module 16 can comprise a plurality of modules that each provide specific individual functionality for processing supply chain events. Supply chain financial orchestration system 10 can also be part of a larger system. Thus, supply chain financial orchestration system 10 can include one or more additional functional modules 18 to include the additional functionality. For example, functional modules 18 may include modules that provide additional functionality, such as “Oracle Fusion Applications” from Oracle Corporation. In another example, functional modules 18 may include enterprise resource planning (“ERP”) modules of an ERP system, where an ERP system is a computer system that integrates several data sources and processes of an organization into a unified system.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

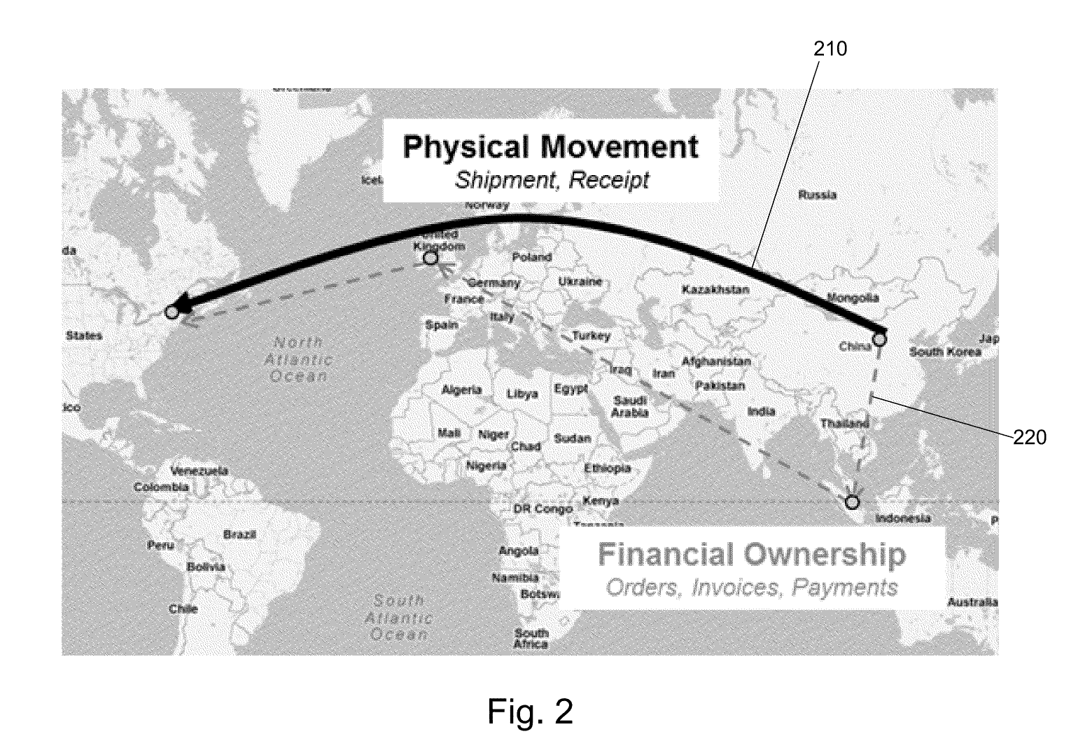

FIG. 2 illustrates an example supply chain financial orchestration flow, according to an embodiment of the invention. The supply chain financial orchestration flow is between a shipping entity in China and a receiving entity in the United States. As illustrated in FIG. 2, the supply chain financial orchestration flow includes a physical movement flow 210 and a financial flow 220. Physical movement flow 210 represents the physical movement of items from the shipping entity in China, to the receiving entity in the United States, and can involve the physical movement through one or more intermediate entities. Physical movement flow 210 can include one or more physical transactions that are executed in association with the physical movement of the items (such as shipments, receipts, etc.). Financial flow 220 represents the change in financial ownership of items from the shipping entity in China, to the receiving entity in the United States, and can involve the change in financial ownership of one or more intermediate entities. Financial flow 220 can include one or more financial transactions that are executed in association with the change in financial ownership of the items (such as orders, invoices, payments, etc.). As illustrated in FIG. 2, a physical movement flow can be separate and independent of a financial flow within a supply chain financial orchestration system.

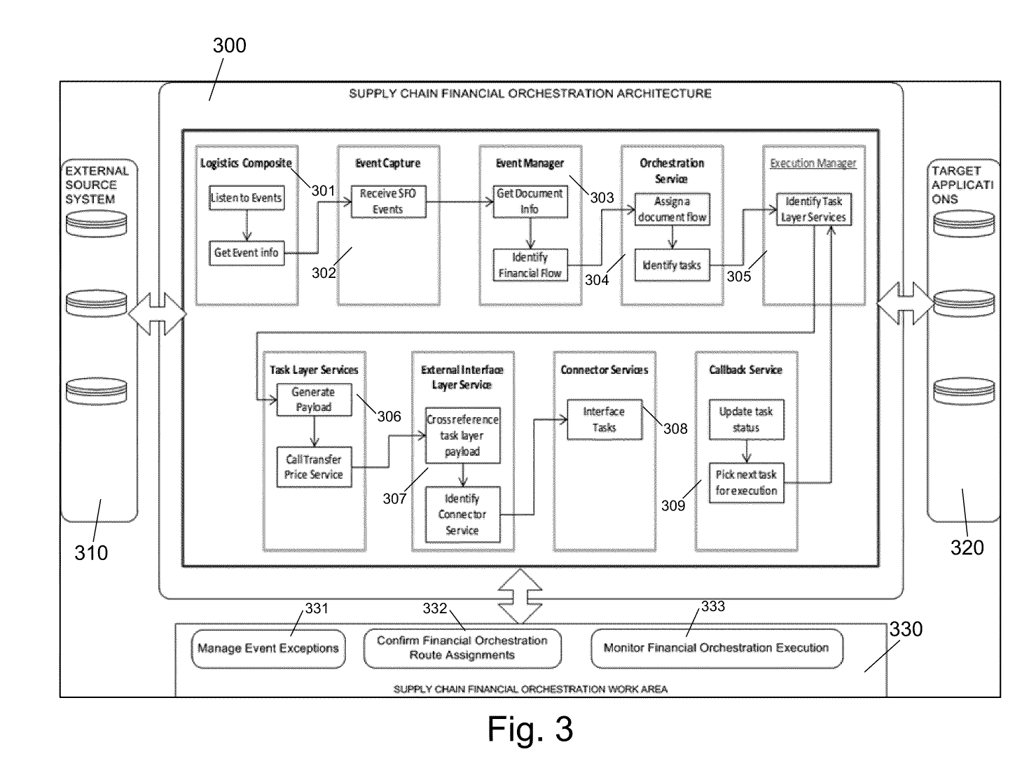

FIG. 3 illustrates a block diagram of an example architecture of a supply chain financial orchestration system 300, according to an embodiment of the invention. According to the embodiment, supply chain financial orchestration system 300 is a configurable system that manages internal trade relationships between entities belonging to an enterprise, where the enterprise is typically spread across geographies. Supply chain financial orchestration system 300 can define a nature of trade relationships, business rules, internal controls, regulatory compliances, and other terms and conditions required to execute, monitor, and evaluate trade transactions emanating out of such relationships. More specifically, supply chain financial orchestration system 300 can listen to events (such as supply chain events) that occur in supply chain transactions in various external source systems, and can identify internal transactions (such as inter-company transactions and intra-company transactions) based on pre-defined trade relationships. Once the internal transactions are identified, supply chain financial orchestration system 300 can create necessary accounting and documentation required to be generated for the internal transactions according to the business rules defined in supply chain financial orchestration system 300.

According to the illustrated embodiment, supply chain financial orchestration system 300 includes event mediator 301, event capture 302, event manager 303, orchestration service 304, execution manager 305, task layer service 306, external interface layer service 307, connector service 308, and callback service 309. Event mediator 301 listens for events generated by an external source system (i.e., application) of external source systems (i.e., applications) 310. If an event is of interest to supply chain financial orchestration system 300, event mediator 301 can also call a web service exposed by the external source system of external source systems 310 to enrich the event details. Event mediator 301 then sends the event to event capture 302. Event capture 302 validates the event details retrieved after enrichment, and stores the event in an external source system format.

Subsequently, event manager 303 identifies a source document enrichment web service based on a source order type, and calls the source document enrichment web service for enrichment. The source document enrichment service is exposed by an external source system of external source systems 310 where the source order originated. Event manager 303 can pass a source document identifier as an input parameter to the enrichment web service and can retrieve the source document information, where a source document identifier is a unique identifier of the source document that is communicated to the external source system of external source systems 310. The external source system of external source systems 310 that is responsible for capturing the physical transaction can be responsible for passing the source document identifier as part of event information. Supply chain financial orchestration system 300 can maintain an association between a supply chain event and a source document type. Event manager 303 can further transform the source document information into a format that is understandable by supply chain financial orchestration system 300, and can identify a supply chain financial orchestration flow based on qualifiers, source document type, physical route, parties involved in an internal trade, and a priority of the supply chain financial orchestration flow. Further, a supply chain financial orchestration flow can be date effective. This means that any modification to a supply chain financial orchestration flow can cause a new effective date to be associated with the supply chain financial orchestration flow. Thus, transactions pertaining to a source document created before the effective date of the modification can be associated with the original supply chain financial orchestration flow, and transactions pertaining to a source document created after the effective date of the modification can be associated with the modified supply chain financial orchestration flow.

Orchestration service 304 verifies whether a supply chain financial orchestration flow is already assigned to a source document or not. If the supply chain financial orchestration flow is not already assigned, orchestration service 304 can assign the supply chain financial orchestration flow to the source document, and can generate the tasks that are to be performed between internal entities based on the documentation and accounting rules setup for the supply chain financial orchestration flow (such as a global procurement flow, a customer shipment flow, and an internal transfer flow). A global procurement flow is a supply chain financial orchestration flow where a central buying entity buys goods from suppliers on behalf of one or more internal entities. The supplier liability is borne by the purchasing entity. The purchasing and requesting entity settle the transaction among themselves using a transfer price (sometimes through one or more intermediary entities). A customer shipment flow is a supply chain financial orchestration flow in which a selling business unit is different from a profit center business unit of the entity that owns and ships the goods. The selling entity receives an order from a customer, and the shipping entity ships the goods directly to the customer. The shipping entity is settled financially by the selling entity (sometimes through one or more intermediary entities). A customer shipment flow can be an internal drop shipment flow, which is a forward customer shipment flow, or a customer drop shipment flow, or a return customer shipment flow. An internal transfer flow is a supply chain financial orchestration flow in which physical movement of goods happens between internal entities. The internal entities settle the financial transactions among themselves using a transfer price.

The tasks that are to be performed can be specific to a forward flow and a return flow for the supply chain financial orchestration flow. A forward flow is a flow of events that proceeds in a specific direction (such as from a supplier entity to a purchaser entity), and a return flow is a flow of events that proceeds in a reverse direction (such as from a purchaser entity to a supplier entity). In addition to ownership transfer between internal entities, events indicating ownership transfer from a supplier entity to a purchasing entity can also be setup in a supply chain financial orchestration flow definition. When an event designated as a supplier ownership change event occurs, orchestration service 304 can generate the tasks for creating trade distributions to book supplier accrual and costs in a costing system, as well. Execution manager 305 invokes a task layer service based on a task type. Generally, the tasks are performed in a defined sequence, and if there is any dependency from a previous task, execution manager 305 can wait for the previous task to complete. Example task types can include inter-company trade documents (e.g., purchase order and sales order), trade distribution tasks related to costing, inter-company receivable invoices related to inter-company receivable, payables invoice, or credit memo tasks that are set in documentation and accounting rules. Task types can also include user-defined tasks.

Task layer service 306 creates a task layer service payload. Task layer service 306 can include logic to populate the payload data depending on a global procurement flow, a customer shipment flow, or an internal transfer flow. Task layer service 306 can also call a transfer price service to get a transfer price, where the transfer price is a price in which a selling entity sells goods to a purchasing entity, where the selling entity and the purchasing entity are involved in an internal trade. External interface layer service 307 identifies a target system (i.e., application) of target systems (i.e., applications) 320, and obtains a connector service (e.g., connector service 308) for the target system of target systems 320 based on the task type. Connector service 308 transforms the task layer service payload into a format which is understandable by the target system of target systems 320. Once the task data is transformed according to a target system format, connector service 308 calls a web service to interface tasks in interface tables of the target system of target systems 320. Callback service 309 receives responses from the target system of target systems 320 and updates the task status. If the task is a last task in a sequence, then the supply chain financial orchestration is complete. Otherwise, the next task in the sequence is selected, and execution manager 305 is invoked with the task type.

Supply chain financial orchestration system 300 further includes a supply chain financial orchestration work area 330 that includes a plurality of user interfaces that allow a user to interact with supply chain financial orchestration system 300. Supply chain financial orchestration work area 330 includes manage event exceptions 331, confirm financial orchestration route assignments 332, and monitor financial orchestration execution 333. Manage event exceptions 331 is a user interface that allows users to view, troubleshoot, and manage events which faulted due to a setup or technical reason. Confirm financial orchestration route assignments 332 is a user interface that allows a user to confirm a supply chain financial orchestration flow before the tasks of the supply chain financial orchestration flow are initiated by orchestration service 304. Monitor financial orchestration execution 333 is a user interface that allows a user to monitor supply chain financial orchestration flows that are in progress, that have not started, and that have completed.

In one embodiment, a supply chain financial orchestration system can have the capability of defining rules for a financial route selection by providing a qualifier rule. The qualifier rule can be evaluated, and can provide a highest priority financial route for the supply chain financial orchestration system. More specifically, an agreement that is defined by a user can define a financial route along with one or more buy/sell terms, one or more pricing rules, and/or one or more documentation and accounting rules to be used for an internal transactions. A user may wish to identify a suitable agreement based on different business parameters, such as supplier, item category, entity, etc. For example, a user may wish to use “Agreement A” for item category “Electronics” and “Agreement B” for item category “Machinery.” Thus, these business parameters can act as qualifiers for agreement identification. According to the embodiment, a qualifier rule can be defined and attached to an agreement. During an execution of a supply chain financial orchestration flow, one or more agreements that are defined for a pair of buying and selling entities of a transaction can be identified, and the one or more qualifier rules attached to the one or more identified agreements can be evaluated, and the appropriate agreement to be used for the transaction can be identified and selected. Without qualifier rules, it can be very difficult to identify an agreement for different combinations of business parameters, and it could require the customization of the source code, including “hard-coding” the agreement usage for different set of business parameters. Qualifier rules can make the process of associating an agreement with a supply chain financial orchestration flow easier.

Additionally, in one embodiment, a supply chain financial orchestration system can orchestrate tasks of a supply chain financial orchestration flow based on a defined date effective setup (i.e., a defined effective start date and a defined effective end date). More specifically, different objects (such as transfer pricing rules or tasks) can be defined in a date effective manner (i.e., defined with an effective start date and an effective end date) within an agreement. A modification to the object (e.g., transfer pricing rule or task) can be made independently for any particular date range without affecting the other objects. Once setup data is identified for a source document, the same setup data can be used for the events arising for that source document, irrespective of the changes made to the setup data after the first event arrival.

For example, when a trigger event arises, an appropriate agreement and tasks for the agreement can be identified for a specified date associated with the event within a table, as shown below:

| Task Name | Effective Start Date | Effective End Date |
|---|---|---|
| T1 | 01-Jan-2010 | 31-Dec-2012 |
| T2 | 01-Jan-2010 | 31-Dec-2012 |
| T3 | 01-Jan-2010 | 31-Dec-2012 |

In the example, an event can be received with a date of “1 Feb. 2010” for a purchase order document, “PO111.” The tasks to be performed are tasks T1, T2, and T3. As shown above, one or more entries can be made in the table for a source document, and the effective date can be used for identifying the tasks. The effective date can then be used to identify the tasks when further events are triggered for that source document. This can ensure that when a setup is changed, future events for the source document will use the already-identified effective date, select the tasks corresponding to the appropriate date range that includes the effective date, and orchestrate the tasks.

In the above example, if an entity needs to additionally perform task T0 for new purchase order documents created in 2011 and onwards, but continue to only perform tasks T1, T2, and T3 for older purchase order documents created in 2010 or earlier, the table can be modified as follows:

| Task Name | Effective Start Date | Effective End Date |
|---|---|---|
| T0 | 01-Jan-2011 | 31-Dec-2012 |
| T1 | 01-Jan-2010 | 31-Dec-2012 |
| T2 | 01-Jan-2010 | 31-Dec-2012 |
| T3 | 01-Jan-2010 | 31-Dec-2012 |

When another event is received for the purchase order document, “PO111,” on Feb. 1, 2011, the supply chain financial orchestration system can refer to the previous entry that was made for the purchase order document, “PO111,” select the effective date as “1 Feb. 2010,” and only perform the tasks T1, T2, and T3. If an event is received for a new purchase order document, “PO222,” on Feb. 1, 2011, then tasks T0, T1, T2, and T3 can be performed. Further, one or more task layer services that prepare a payload can also refer to the effective date indicated in the table, and select the data for the appropriate date range. Thus, a date effectivity feature can assist a user in adding or removing transfer pricing rules or tasks for any given date range. Without this feature, it is very difficult for a user to specify different sets of transfer pricing rules and/or tasks for an agreement with different date ranges. Thus, the date effectivity feature can help a user configure a setup in accordance with modifications to business requirements.

Further, in one embodiment, a supply chain financial orchestration system can provide objects (such as transfer pricing rules or tasks) with both date effectivity and multiple language support (“MLS”). Thus, the supply chain financial orchestration system can enable a user to create multi-lingual objects that also extend the date effectivity behavior previously described. By extending the date effectivity behavior into MLS-enabled attributes, the supply chain financial orchestration system can keep track of modifications to MLS-enabled attributes. The supply chain financial orchestration system can enable support for date effective operations, such as “Create,” “Retrieve,” “Insert,” “Correct,” “End Date,” and “Delete,” as well as operations, such as import and export of setup date between systems. By utilizing this framework, a user can enable date effective behavior for MLS entities. Without this framework, a user would likely have to manually create source code to support date effective operations for translatable attributes, or would have to drop either the date effectivity behavior or the MLS-enabled attributes.

According to an embodiment, as previously described, a supply chain financial orchestration system can configure one or more supply chain events as task generating events that indicate tasks to be executed. An example of a task generating event is an ownership change event that indicates an ownership change of an item from a first entity to a second entity for an internal transaction associated with a supply chain financial orchestration flow. The one or more supply chain events can be pre-defined events, where the supply chain events are defined by the supply chain financial orchestration system. For example, for a global procurement flow: an advanced shipment notice event can be defined to indicate that goods are shipped or are ready for shipment or delivery; a purchase order (“PO”) receipt event can be defined to indicate receipt of goods at a warehouse, or a fulfillment of a service against a PO; a return to vendor event can be defined to indicate a return of goods to a supplier; and an accounts payable (“AP”) invoice match can be defined to indicate a receipt and booking of an invoice received from a supplier. For a customer shipment flow: a sales order (“SO”) shipment event can be defined to indicate a shipment of goods against a sales order; and a return material authorization (“RMA”) receipt event can be defined to indicate a receipt of goods returned by a customer against an RMA. For an internal transfer flow: an internal shipment event can be defined to indicate a shipment of goods from one internal location (such as a warehouse) to another internal location against an internal transaction or a transfer order; and an internal receipt event can be defined to indicate a receipt of goods against an internal transaction or a transfer order. In alternate embodiments, other supply chain events can be configured as ownership change events by the supply chain financial orchestration system. Another example of a task generating event is a documentation creation event that indicates a creation of one or more documents. The documentation creation event can trigger the creation of one or more documents.

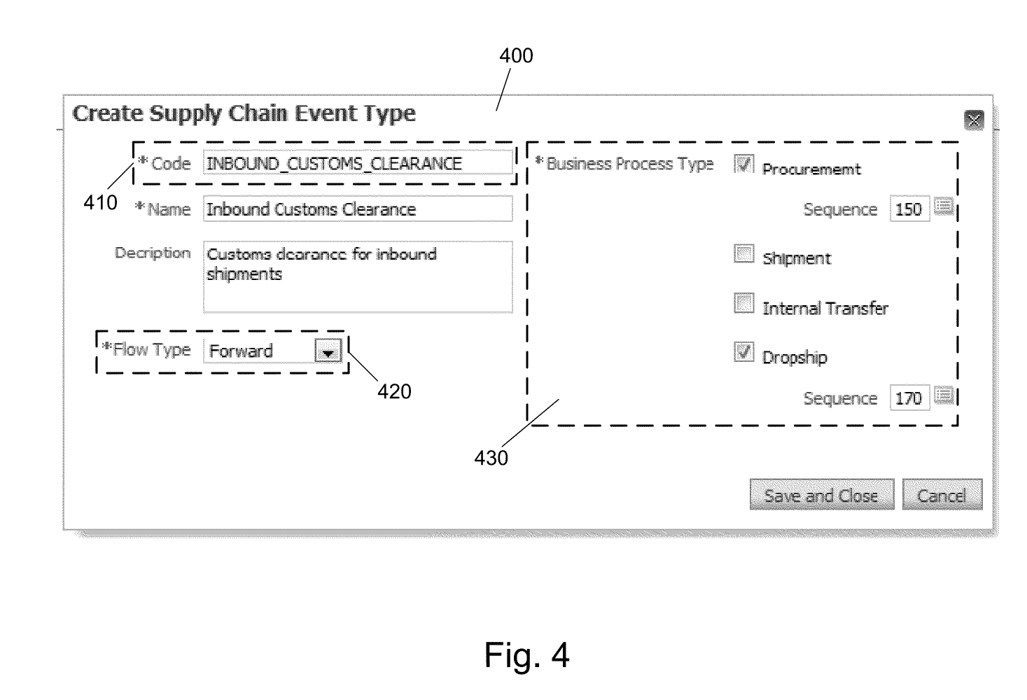

FIG. 4 illustrates an example user interface 400 for defining a supply chain event type, according to an embodiment of the invention. According to an embodiment, in addition to pre-defined supply chain events, a supply chain financial orchestration system can support creation of user-defined supply chain event types. A supply chain event type is an event definition that can be used by the supply chain financial orchestration system to create one or more instances of the supply chain event type (i.e., one or more supply chain events). Further, a user-defined supply chain event type is a supply chain event type that can be created by a user of a supply chain financial orchestration system, rather than by the supply chain financial orchestration system itself.

According to the illustrated embodiment, a user-defined event type can be defined to include a code using code window 410, where a code is a unique identifier of the user-defined event type. Further, a user-defined event type can be defined so that instances of the user-defined event type can be used in either a forward flow or a return flow of a supply chain financial orchestration flow using flow type 420. Instances of the user-defined event type can also be defined to be used in one or more supply chain financial orchestration flow types (identified in FIG. 4 as “business process types”) using business process type window 430. Example supply chain financial orchestration flow types include a global procurement flow (identified in FIG. 4 as “Procurement”), an internal drop shipment flow (identified in FIG. 4 as “Shipment”), a customer drop shipment flow (identified in FIG. 4 as “Dropship”), or an internal transfer flow (identified in FIG. 4 as “Internal Transfer”).

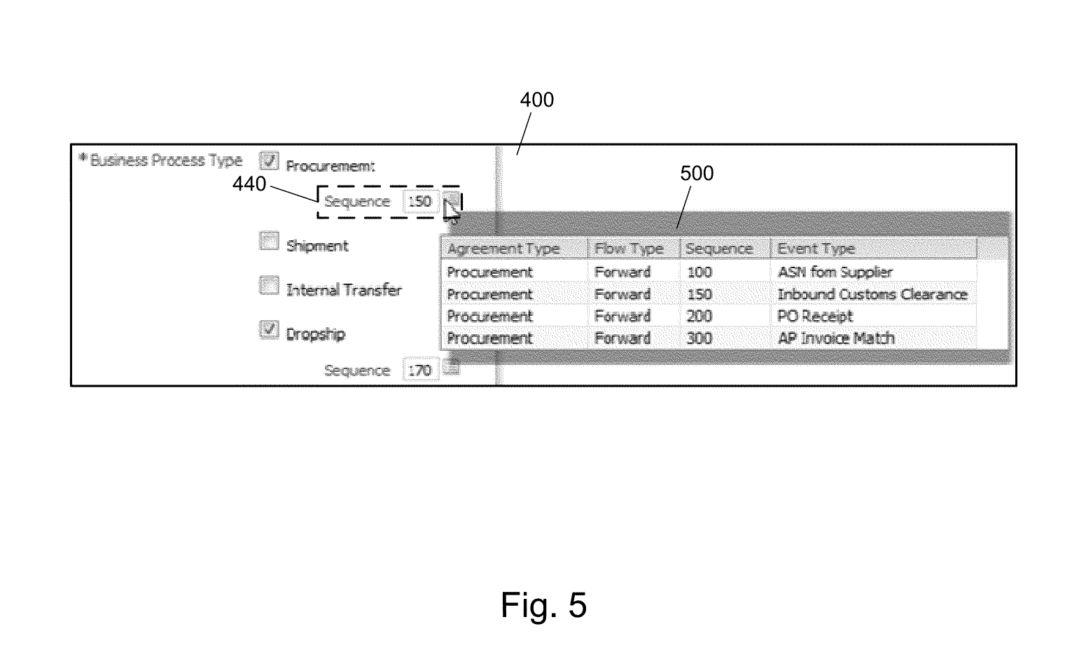

FIG. 5 illustrates an example user interface 500 for assigning a sequence number to a supply chain event type, according to an embodiment of the invention. According to the embodiment, one or more supply chain events (where the one or more supply chain events can be instances of a supply chain event type) that are used in a supply chain financial orchestration flow can be assigned to a unique sequence number which specifies the order in which the one or more supply chain events occur in the supply chain financial orchestration flow. For example, a receipt against a purchase order event is generally expected to occur after an advance shipment notice event is sent by a supplier. In a scenario where a supply chain financial orchestration system receives a supply chain event before receiving the supply chain event's predecessor supply chain event (generally due to technical reasons), the use of the unique sequence number allows the supply chain financial orchestration system to wait for the predecessor supply chain event to be interfaced before processing the subsequent supply chain event.

According to the illustrated embodiment of FIG. 5, user interface 400 can further include sequence number window 440. As illustrated in FIG. 5, user interface 400 can display a similar sequence number window for each supply chain financial orchestration flow type that the user-defined supply chain event type is associated with. Using sequence number window 440 (or a similar sequence number window for a different supply chain financial orchestration flow type), a user can assign a unique sequence number to the user-defined supply chain event type for a supply chain financial orchestration flow type, where the unique sequence number defines when instances of the user-defined supply chain event type occur with respect to instances of other supply chain event types defined for the supply chain financial orchestration flow type. Further, as illustrated in FIG. 5, user interface 500 can be displayed to indicate the supply chain event types associated with the supply chain financial orchestration flow type, and the sequence number assigned to each supply chain event type.

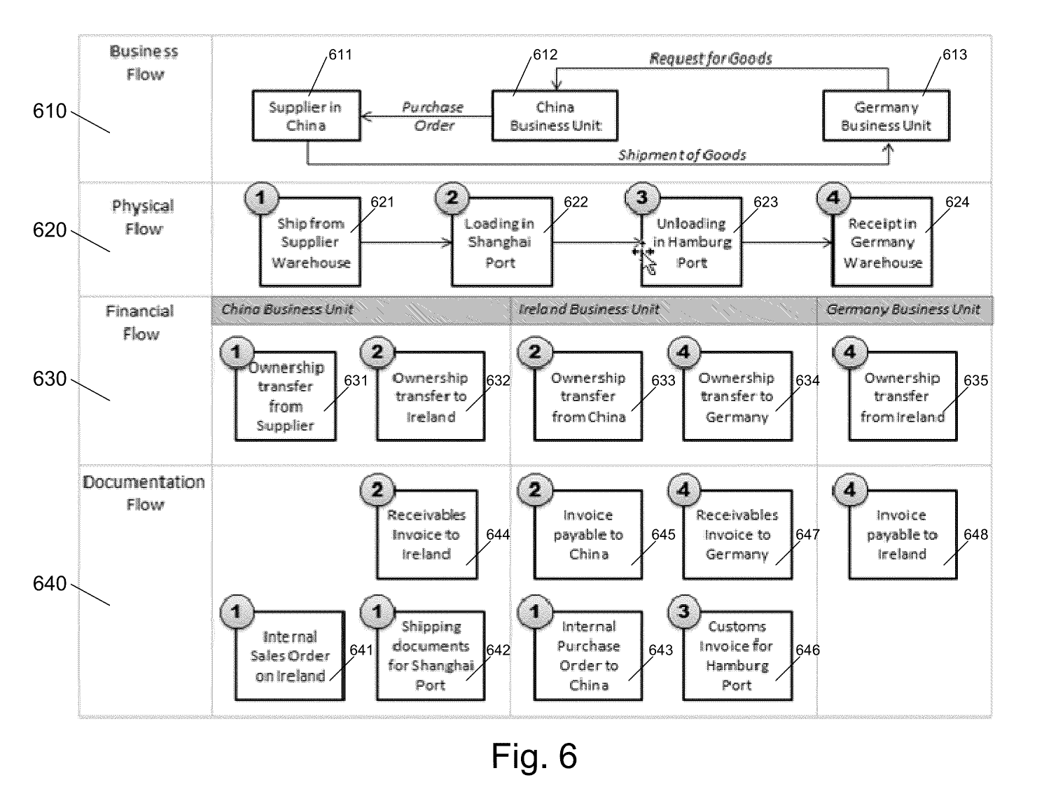

FIG. 6 illustrates an example supply chain financial orchestration flow, according to an embodiment of the invention. As previously described, an accounting of ownership transfers are generally tied to a physical transaction. For example, a liability to a supplier can be recognized in a buyer's books when goods are received in the buyer's warehouse. However, as also previous described, in an international trade, generally, an ownership transfer between entities may not necessarily occur on receipt of goods at the destination. For example, the ownership may be transferred to the buyer when the goods have crossed an international border. Accounting principles mandate that the account books be updated to reflect the actual ownership changes. Thus, in this example, the financial flow deviates from the physical flow.

The example supply chain financial orchestration flow illustrated in FIG. 6 is another example of a separation of a physical flow from a financial flow. According to the illustrated embodiment, the supply chain financial orchestration flow includes business flow 610, physical flow 620, financial flow 630, and documentation flow 640. Business flow 610, physical flow 620, financial flow 630, and documentation flow 640 each represent a different type of event flow.

Business flow 610 is an event flow that includes one or more business events. According to the illustrated embodiment, a business group headquartered in Ireland has legal entities registered in Ireland, China, and Germany. A manufacturing business unit in Hamburg, Germany belongs to the Germany legal entity. A business unit performing procurement functions for the business group belongs to the China legal entity. All purchases sourced from China can be required to be procured through the China legal entity. Thus, a requisition placed for demand of supplies in the Hamburg manufacturing business unit (illustrated in FIG. 6 as Germany business unit 613), when identified to be procured from China, is picked up by the procurement business unit in China (illustrated in FIG. 6 as China business unit 612). The procurement business unit in China (i.e., China business unit 612) creates a purchase order and sends the purchase order to a supplier in China (illustrated in FIG. 6 as supplier 611), instructing the supplier in China (i.e., supplier 611) to ship the goods to the Hamburg manufacturing business unit (i.e., Germany business unit 613). The business group's supply chain policies, in order to achieve tax efficiency, can mandate that all intercompany flows are to be routed through the group headquarters in Ireland.

Physical flow 620 is an event flow that includes one or more physical events. According to the illustrated embodiment, once the goods are ready for shipment, the supplier hands over the goods to the buyer's shipping agent to ship the goods to Hamburg through sea. The supplier sends an advance shipment notice to the buyer, the China legal entity, before shipment. The supplier also generates an invoice and sends the invoice to the China legal entity for payment. Thus, as illustrated in FIG. 6, significant physical events, such as the shipping of the goods from the supplier's warehouse (illustrated in FIG. 6 as physical event 621), the loading of the goods at the Shanghai port (illustrated in FIG. 6 as physical event 622), the unloading of the goods at the Hamburg port (illustrated in FIG. 6 as physical event 623), and delivery of the goods at the Hamburg warehouse (illustrated in FIG. 6 as physical event 624), occur during the transportation of the goods from the supplier's warehouse in China to the warehouse in Hamburg, Germany.

Financial flow 630 is an event flow that includes one or more ownership change events. According to the illustrated embodiment, the ownership of the goods is transferred from the supplier to the China legal entity when the goods are shipped out of the supplier's warehouse (illustrated in FIG. 6 as ownership change event 631, where ownership change event 631 corresponds to physical event 621). At this point in time, the China legal entity entities to the ownership of the goods and also is liable to play the supplier. The ownership of the goods is subsequently transferred from the China legal entity to the Ireland legal entity when the goods arrive in the Shanghai port (illustrated in FIG. 6 as ownership change events 632 and 633, where ownership change events 632 and 633 correspond to physical event 622). At this point in time, the China legal entity can account for the revenue and the cost of the goods sold to the Ireland legal entity in its accounting books. Further, at this point in time, the Ireland legal entity entitles the goods and also is liable to pay the China legal entity. The ownership of the goods is subsequently transferred from the Ireland legal entity to the Germany legal entity when the goods are received in the Germany warehouse (illustrated in FIG. 6 as ownership change events 634 and 635, where ownership change events 634 and 635 correspond to physical event 624). At this point in time, the Ireland legal entity can account for the revenue and the cost of goods sold to the Germany legal entity in its accounting books. Further, at this point in time, the Germany legal entity entitles the goods and also is liable to pay the Ireland legal entity. Thus, the different aspects the ownership transfer of goods, such as the cost, revenue, receivables and payables, can be booked in the accounting books of the parties involved in the trade at the appropriate point in time.

Documentation flow 640 is an event flow that includes one or more documentation creation events. In a transaction involving ownership transfer, receivable and payable invoices can be generated and booked in both seller's and buyer's accounting books, usually at a time of ownership transfer. However, there can also be a need for additional documents to be generated, such as shipping documents that can be created by different entities before, or after, ownership transfer.

According to the illustrated embodiment, all trade involving the China legal entity can be backed by documentation, such as purchase orders and/or sales orders. Thus, a sales order document is generated by the China legal entity with the Ireland legal entity as customer when the goods are shipped out of the supplier's warehouse in China (illustrated in FIG. 6 as documentation creation event 641, where documentation creation event 641 corresponds to physical event 621). At the same time, a purchase order document is generated by the Ireland legal entity with the China legal entity as the supplier (illustrated in FIG. 6 as documentation creation event 643, where documentation creation event 643 also corresponds to physical event 621). The sales order and purchase order documents may be required to be generated right at the time of shipment before the actual ownership transfer happens between the China legal entity and the Ireland legal entity, since these documents can become the documents based on which shipping documents and/or other financial documents are generated. Additionally, if shipping documents are required, at the same time, one or more shipping documents can be generated (illustrated in FIG. 6 as documentation creation event 642, where documentation creation event 642 also corresponds to physical event 621).

Further, a receivables invoice to the Ireland legal entity is generated and an invoice payment to the China legal entity is also generated when the goods are loaded at the Shanghai port (illustrated in FIG. 6 as documentation creation events 644 and 645, where documentation creation events 644 and 645 correspond to physical event 622). Additionally, the unloading of the goods at the Hamburg port may require the generation of customs documents. In this scenario, one or more customs documents can be generated (illustrated in FIG. 6 as documentation creation event 646, where documentation creation event 646 corresponds to physical event 623). Finally, a receivables invoice to the Germany legal entity is generated and an invoice payment to the Ireland legal entity is also generated when the goods are received at the Germany warehouse (illustrated in FIG. 6 as documentation creation events 644 and 645, where documentation creation events 644 and 645 correspond to physical event 622).

Thus, the orchestration of supply chain financial orchestration flows involving multiple business units can require that the supply chain financial orchestration system identify the different events and trigger the ownership change accounting and financial documentation creation at the appropriate time. In order to effectuate such identifying and triggering, one or more supply chain events can be configured as ownership change events and/or documentation creation events, as is described below in greater detail.

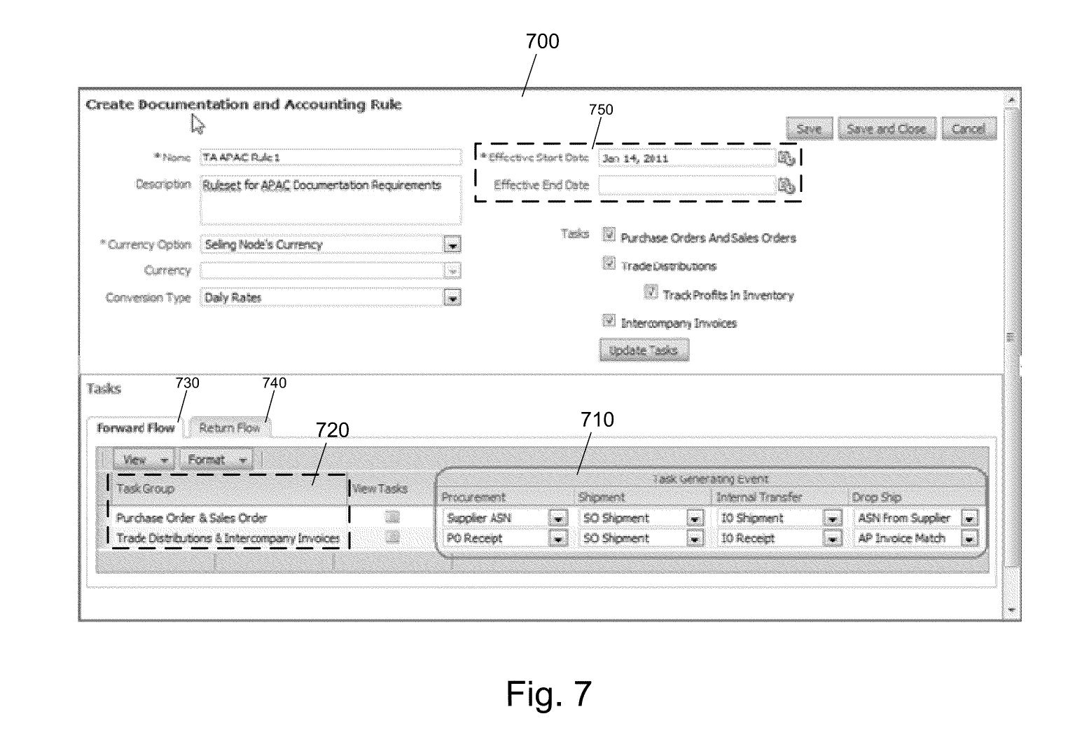

FIG. 7 illustrates an example user interface 700 for configuring a supply chain event as an ownership change event by defining a documentation and accounting rule, according to an embodiment of the invention. A documentation and accounting rule is a rule that can define one or more tasks to be performed in response to a supply chain event. According to the embodiment, a supply chain event can be configured as a task generating event within the documentation and accounting rule, where the task generating event triggers the execution of the one or more tasks. Thus, when a supply chain financial orchestration system receives a supply chain event that can be raised as part of a transaction associated with a supply chain financial orchestration flow, and applies the documentation and accounting rule, the supply chain financial orchestration system can determine that the supply chain event is the task generating event and execute the one or more tasks. The documentation and accounting rule can be defined as part of an agreement (also identified as a “buy and sell term”), where the agreement is defined between two entities, and where the agreement associated with the supply chain financial orchestration flow. In one embodiment, the task generating event can be an ownership change event, and the one or more tasks can be financial tasks that effect an ownership change of an item from a first entity to a second entity. In another embodiment, the task generating event can be a documentation creation event, and the one or more tasks can be tasks that create one or more documents (such as a purchase order, a sales order, or a customs invoice) either prior to, or subsequent to, an ownership change of the item from the first entity to the second entity.

According to the illustrated embodiment, one or more supply chain events can be defined as task generating events using task generating event window 710. Each supply chain event can be defined as a task generating event for a supply chain financial orchestration flow type (i.e., business process type). Example supply chain financial orchestration flow types include a global procurement flow (identified in FIG. 7 as “Procurement”), an internal drop shipment flow (identified in FIG. 7 as “Shipment”), a customer drop shipment flow (identified in FIG. 7 as “Drop Ship”), or an internal transfer flow (identified in FIG. 7 as “Internal Transfer”). Further, according to the illustrated embodiment, one or more task generating events can be grouped into a task group using task group window 720. A task group is a collection of one or more logically-related tasks, where the one or more logically-related tasks may need to be executed upon a reception of a supply chain event. Example task groups can include “Purchase Order & Sales Order” and “Trade Distributions & Intercompany Invoices.” The task group “Purchase Order & Sales Order” can include the tasks “Purchase Order” and “Sales Order.” Further, the task group “Trade Distributions & Intercompany Invoices” can include the tasks “Trade In-transit Issue,” “Trade Receipt Accrual,” “Trade In-transit Receipt,” “Intercompany AR Invoice,” and “Intercompany AP Invoice.” As is described below in greater detail in conjunction with FIG. 7, a user can further create one or more user-defined tasks, and can assign the user-defined tasks to pre-defined task groups or user-defined task groups.

Also according to the illustrated embodiment, one or more supply chain events can be defined as task generating events for a forward flow using forward flow tab 730, and an additional set of one or more supply chain events can be defined as task generating events for a return flow using return flow tab 740. As previously described, a supply chain financial orchestration flow can include a forward flow and a return flow, where a forward flow is a flow of events that proceeds in a specific direction (such as from a supplier entity to a purchaser entity), and where a return flow is a flow of events that proceeds in a reverse direction (such as from a purchaser entity to a supplier entity).

In one embodiment, a documentation and accounting rule that is defined using user interface 700 can be defined to be date effective, using effective date window 750. A date effective object (e.g., a date effective documentation and accounting rule) is an object that has attributes whose values change over time. The date effective object can retain a complete history of all modifications and the time periods during which each modification is available for use in transactions. In other words, “date effective” allows users to make modifications to an object (e.g., documentation and accounting rule) that can take effect in the future. Thus, for a date effective documentation and accounting rule, any modifications to the date effective documentation and accounting rule can be created with an effective date for the modification. Transactions associated with new source documents created after an effective date can utilize the modified documentation and accounting rule to identify a supply chain event as a task generating event and to execute one or more tasks, while transactions associated with original source documents created before the effective date can utilize the original documentation and accounting rule to identify a supply chain event as a task generating event and to execute one or more tasks. A supply chain financial orchestration system, when deriving the documentation and accounting rules for identifying a supply chain event as a task generating event and for executing one or more tasks, can retrieve the documentation and accounting rules that are effective as of an effective date for a source document.

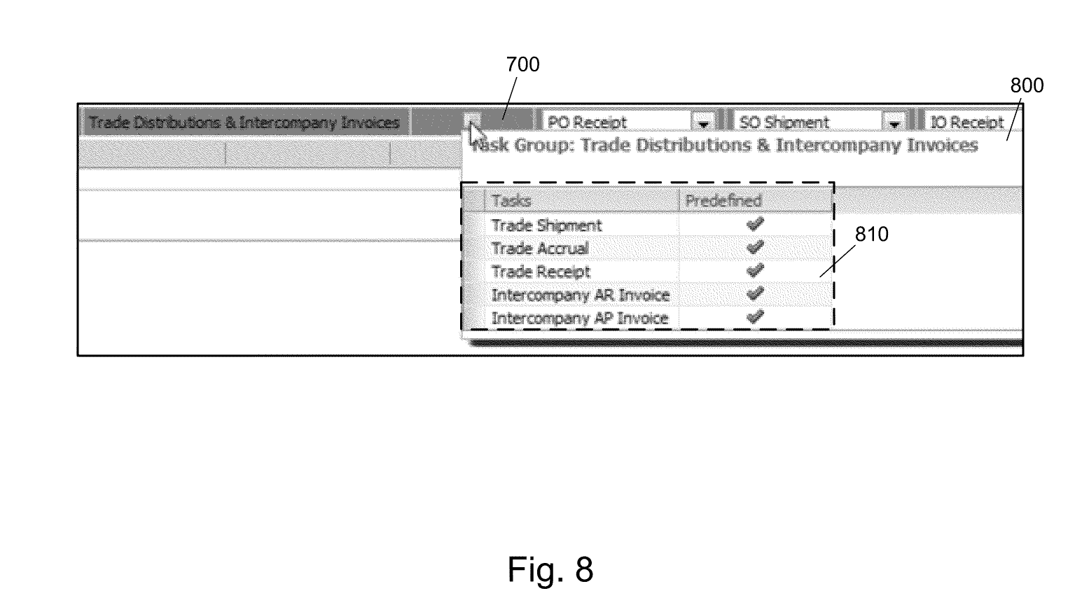

FIG. 8 illustrates an example user interface 800 for defining one or more tasks for a documentation and accounting rule, according to an embodiment of the invention. According to the illustrated embodiment, a user can select a task group within user interface 700 of FIG. 7, and cause user interface 800 to be displayed. User interface 800 displays one or more tasks of the task group, and further displays whether each task is pre-defined or user-defined. A user can add one or more new tasks to the task group, or can delete one or more existing tasks from the task group.

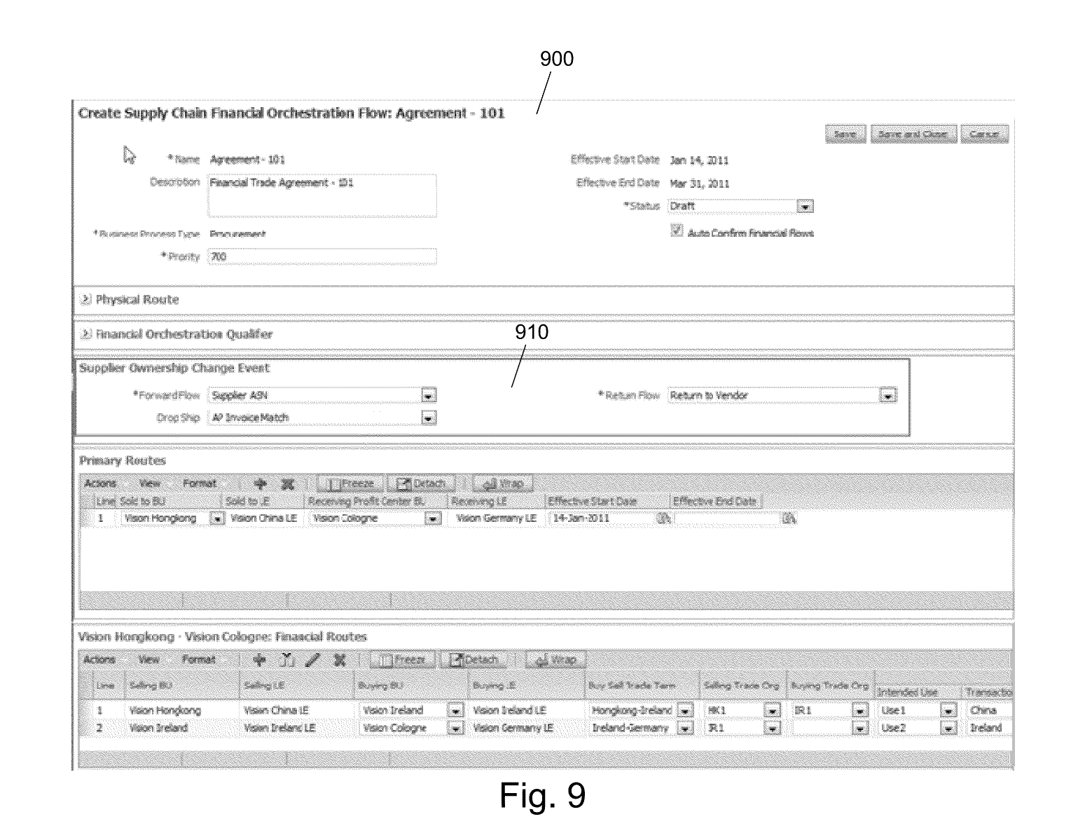

FIG. 9 illustrates an example user interface 900 for configuring a supply chain event as a supplier ownership change event, according to an embodiment of the invention. As previously described, in addition to ownership transfer between internal entities, events indicating ownership transfer from a supplier entity to a purchasing entity can also be configured within an agreement that is defined for a supply chain financial orchestration flow. When an event designated as a supplier ownership change event occurs, a supply chain financial orchestration system can generate the tasks for creating trade distributions to book supplier accrual and costs in a costing system. According to the illustrated embodiment, one or more supply chain events can be defined as supplier ownership change events using supplier ownership change event window 910. Each supply chain event can be defined as a supplier ownership change event for a supply chain financial orchestration flow type (i.e., business flow type). Further, a supply chain event can be defined as a supplier ownership change event for a forward flow, and a separate supply chain event can be defined as a supplier ownership change event for a return flow.

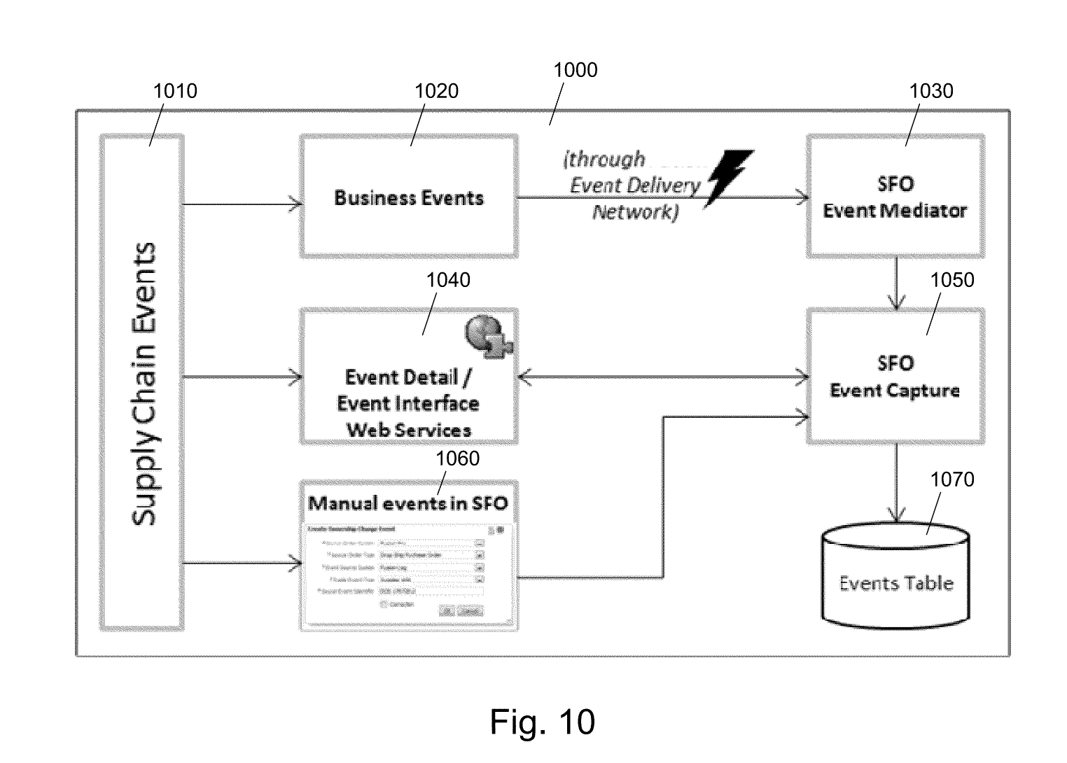

FIG. 10 illustrates a block diagram of an event framework 1000 that receives and processes supply chain events, according to an embodiment of the invention. According to the embodiment, an execution of a supply chain financial orchestration flow can produce supply chain events (illustrated in FIG. 10 as supply chain events 1010). As previously described, a supply chain event is an event that occurs in a process of execution of a supply chain financial orchestration flow. A supply chain financial orchestration system can listen for occurrences of these supply chain events. More specifically, a supply chain financial orchestration system can receive a supply chain event by one of the following three methods: (1) receiving a supply chain event through a business event that is raised within an event delivery network (illustrated in FIG. 10 as business events 1020) at an event mediator service (illustrated in FIG. 10 as event mediator 1030), where the business event is raised by an external application; (2) receiving a supply chain event through a direct service invocation from an event interface (illustrated in FIG. 10 as event interface 1040) at an event capture service (illustrated in FIG. 10 as event capture 1050); or (3) receiving a manually created supply chain event (illustrated in FIG. 10 as manual events 1060) at the event capture service. In certain embodiments, event mediator 1030 of FIG. 10 is identical to event mediator 301 of FIG. 3. Further, in certain embodiments, event capture 1050 of FIG. 10 is identical to event capture 302 of FIG. 3.

With respect to (1), an event delivery network is a middleware component that utilizes a publish-subscribe model to push business events to one or more subscribers. A business event is a one-way, asynchronous event used to send a notification of a business occurrence, where a publisher does not rely on any specific service component receiving the business event to complete. An event-driven language is a schema that can be used to build one or more business event definitions, where a business event is an instance of a business event definition. In one embodiment, the event-driven language can include a JAVA® package name and a payload definition. According to the embodiment, an external application raises one or more business events. The raised business events are then published to an event delivery network. The event delivery network can run within every service-oriented architecture (“SOA”) instance. The raised business events are then delivered by the event delivery network to one or more subscribing service components. One or more event mediator services (such as event mediator 1030 of FIG. 10), and optionally one or more business process execution language (“BPEL”) services, can subscribe to, and publish, the raised business events. According to the embodiment, the publisher (e.g., the external application) does not care if any other service components receive the business events, and is not required to know where the other subscribers (if any) are, or what the other subscribers do with the data contained within the raised business events.

Further, with respect to (1), supply chain events that are raised as business events within the event driven network are received by an event mediator service (illustrated in FIG. 10 as event mediator 1030), which subscribes to business events raised within the event driven network. Once these supply chain events are received, if the supply chain events are configured as task generating events, one or more web services of the source application (illustrated in FIG. 10 as event interface 1040) are called in order to get additional information required to process the supply chain events.

With respect to (2), a direct service invocation, unlike a business event, relies on a web services description language (“WSDL”) file contract, such as a simple object access protocol (“SOAP”) service client. If an author of a supply chain event depends on a receiver of the supply chain event, then the messaging is typically accomplished through a service invocation rather than through a business event. Unlike a business event, a direct service invocation does not separate an author of a supply chain event from a receiver. Thus, supply chain events that are raised as direct service invocations to an event capture service (illustrated in FIG. 10 as event capture 1050) are received by the event capture service. The event capture service then determines whether the supply chain events are configured as task generating events. The event capture service subsequently processes the supply chain events when the supply chain events are determined to be configured as task generating services.

With respect to (3), manual supply chain events are received by the event capture service (illustrated in FIG. 10 as event capture 1050). The event capture service then determines whether the supply chain events are configured as task generating events. The event capture service subsequently processes the supply chain events when the supply chain events are configured as determined to be task generating services. Manual supply chain events are further described below in greater detail in conjunction with FIG. 10.

Subsequently, the supply chain events that are received according to one of the aforementioned three methods are populated in a table of a database (illustrated in FIG. 10 as events table 1070 of FIG. 10). The supply chain events are then available for processing by one or more downstream processes.

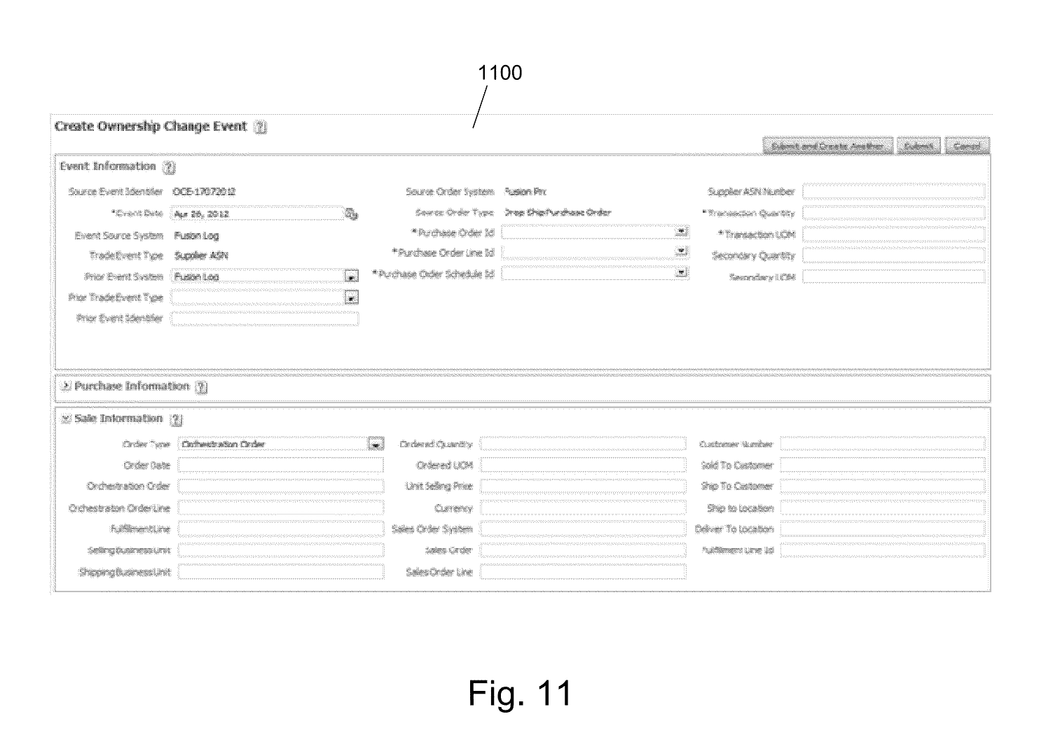

FIG. 11 illustrates an example user interface 1100 for manually creating an ownership change event, according to an embodiment of the invention. In addition to the aforementioned methods for automatic interface of supply chain events to a supply chain financial orchestration system, user interface 1100 is provided that allows a user to manually create a supply chain event (specifically, an ownership change event) by manually entering details of the supply chain event, and manually submitting the supply chain event to an event capture service. According to the illustrated embodiment, examples of event details include: an event identifier, an event date, an event source system, a trade event type, a source order system, and a source order type. User interface 1100 can be used for a type of supply chain event that rarely occurs, and thus, building and maintaining an automatic interface could be relatively expensive. User interface 1100 can also be used to update a supply chain financial orchestration system with supply chain events that were lost in an automatic interface due to technical reasons.

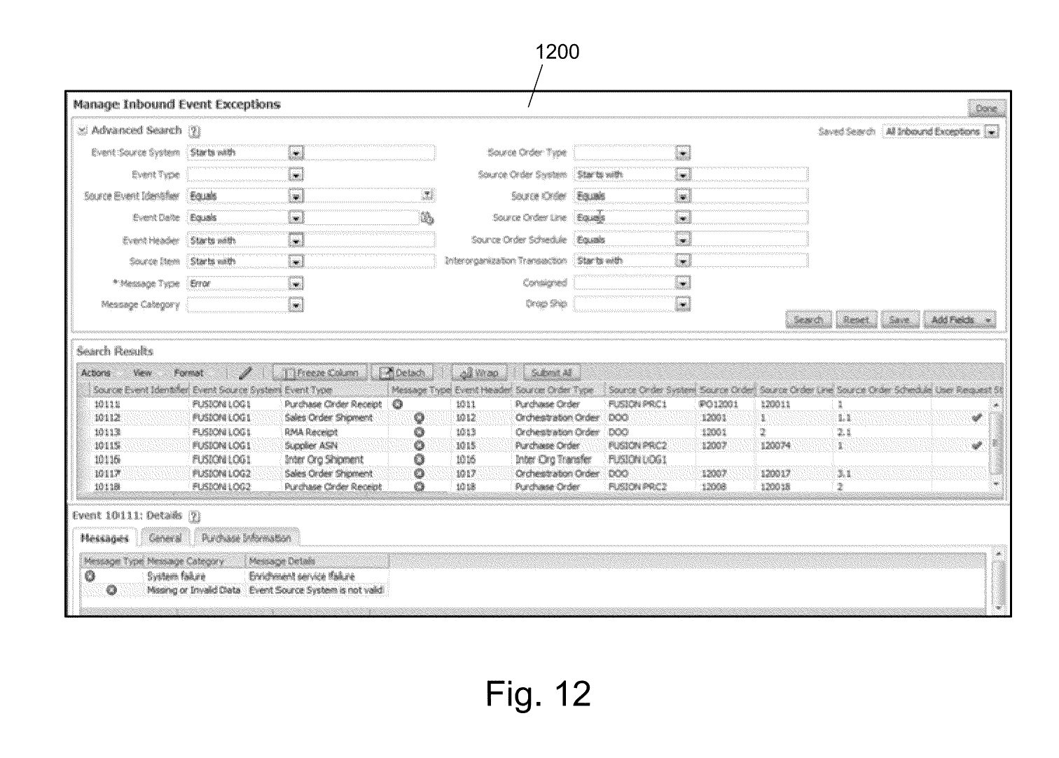

FIG. 12 illustrates an example user interface 1200 for managing supply chain event exceptions, according to an embodiment of the invention. According to the embodiment, user interface 1200 is a workbench that can be provided by a supply chain financial orchestration system in order for a user to view supply chain events that raised one or more exceptions due to technical or functional reasons. Such situations where an exception can be raised include: (a) event data validation failure; (b) unavailability of a service; or (c) absence of an eligible supply chain financial orchestration flow that is configured by a user. User interface 1200 can further provide an option to submit a supply chain event that raised one or more exceptions for re-processing.

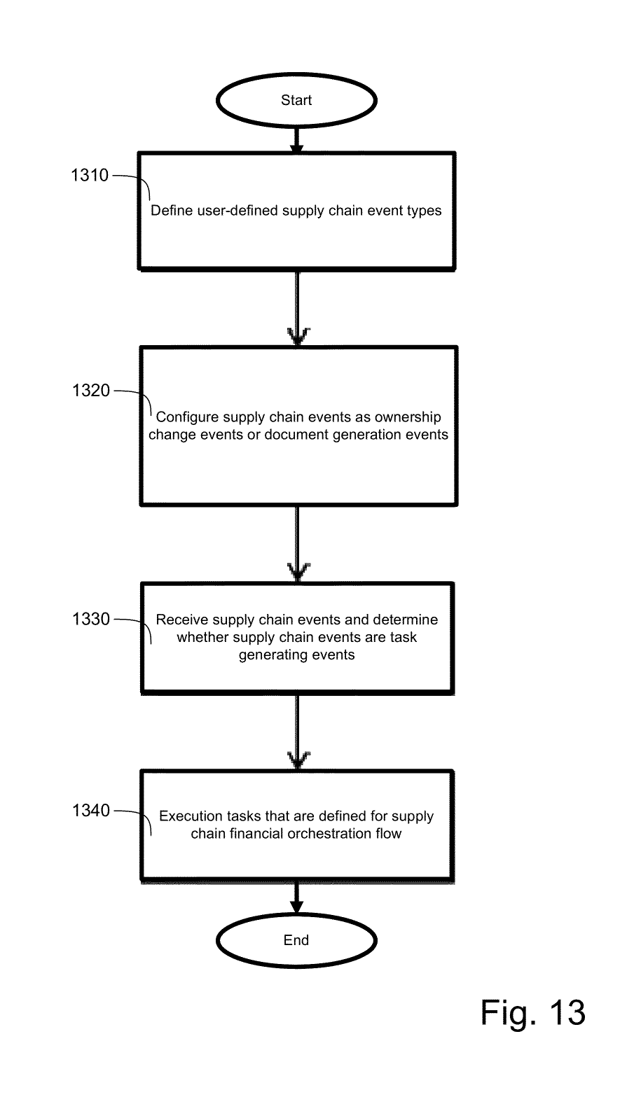

FIG. 13 illustrates a flow diagram of the functionality of a supply chain financial orchestration event module (such as supply chain financial orchestration event module 16 of FIG. 1), according to an embodiment of the invention. In one embodiment, the functionality of the flow diagram of FIG. 13 is implemented by software stored in memory or other computer-readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

The flow begins and proceeds to 1310. At 1310, a supply chain event type is defined. A supply chain event type is an event definition that can be used to create one or more instances of the supply chain event type (i.e., one or more supply chain events). A supply chain event is an event that occurs in a process of execution of a supply chain financial orchestration flow. A supply chain event can be a physical event, such as a shipment of goods, a transit of goods in a named port or other destination, or a receipt of goods at a delivery location. A supply chain event can also be a non-physical event, such as a receipt or dispatch of a commercial invoice, a customs clearance at a port of entry, or a confirmation of a fulfillment of a service. In some embodiments, the supply chain event type is defined by a supply chain financial orchestration system. In other embodiments, the supply chain event type is user-defined. A user-defined supply chain event type is a supply chain event type that can be defined by a user of a supply chain financial orchestration system, rather than by the supply chain financial orchestration system itself. Further, a supply chain financial orchestration flow defines a trade relationship between a first entity and a second entity. In certain embodiments, the supply chain financial orchestration flow can be an internal transaction, the first entity can be a first internal entity, and the second entity can be a second internal entity. The flow then proceeds to 1320.

At 1320, a supply chain event of the supply chain event type is configured as a task generating event, where the task generating event indicates that one or more tasks that are defined for the supply chain financial orchestration flow are to be executed. In certain embodiments, the task generating event can be an ownership change event, where the ownership change event indicates an ownership change of an item from the first entity to the second entity. In some of these embodiments, the ownership change event can be a supplier ownership change event, where the first entity can be an internal entity, and the second entity can be an external entity. In other embodiments, the task generating event can be a documentation creation event, where the documentation creation event indicates a creation of one or more documents.

In certain embodiments, in order to configure the supply chain event as the task generating event, the following actions are performed. First, an agreement associated with the supply chain financial orchestration flow is defined. Next, a documentation and accounting rule for the agreement is defined. Subsequently, the one or more tasks are defined for the documentation and accounting rule. Next, the one or more tasks are grouped into a task group. Finally, the supply chain event is defined as a task generating event for the task group.

In some of these embodiments, where the supply chain financial orchestration flow includes a forward flow and a return flow, in order to configure the supply chain event as the task generating event, the following actions are also performed. First, a forward flow and a return flow are defined for the documentation and accounting rule. Next, one or more tasks are defined for the forward flow, and one or more tasks are defined for the return flow. Subsequently, one or more tasks are grouped for the forward flow and one or more tasks are grouped for the return flow. Finally, the supply chain event is defined as the task generating event for both the forward flow and the return flow.

Further, in some of these embodiments where there are multiple supply chain financial orchestration flows, in order to configure the supply chain event as the task generating event, the following actions are also performed. First, a plurality of supply chain financial orchestration flows are defined for the documentation and accounting rule. Next, one or more tasks are defined for each supply chain financial orchestration flow. Subsequently, one or more tasks of each supply chain financial orchestration flow are grouped into a supply chain financial orchestration flow task group. Finally, the supply chain event is defined as the task generating event for each supply chain financial orchestration flow task group. The flow then proceeds to 1330.

At 1330, a supply chain event is received, where the supply chain event is associated with the supply chain financial orchestration flow. Once the supply chain event is received, it is determined whether the supply chain event is a task generating event. The flow then proceeds to 1340.

At 1340, if the supply chain event is a task generating event, the one or more tasks that are defined for the supply chain financial orchestration flow are executed. In embodiments where the task generating event is an ownership change event, the one or more tasks can include one or more financial tasks that change the ownership of the item from the first entity to the second entity. In some of these embodiments, at least one of the financial tasks can perform accounting based on the ownership change of the item from the first entity to the second entity. In other embodiments where the task generating event is a documentation creation event, the one or more tasks can include one or more tasks that create one or more documents. The flow then ends.

Thus, in one embodiment, a supply chain financial orchestration system can allow a user to configure one or more supply chain events as task generating events, such as ownership change events or documentation creation events. This provides added flexibility in configuring a supply chain financial orchestration flow, as a user can select a supply chain event from multiple supply chain events to define as a task generating event, or even define his or her own user-defined supply chain event as a task generating event. Thus, the supply chain financial orchestration system can provide for a more robust configuration of a supply chain flow.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to process supply chain events, the processing comprising:
defining a supply chain event type;
configuring a supply chain event of the supply chain event type as a task generating event, wherein the task generating event indicates that one or more tasks that are defined for a supply chain financial orchestration flow are to be executed, and wherein the supply chain financial orchestration flow defines a trade relationship between a first entity and a second entity;
receiving a supply chain event associated with the supply chain financial orchestration flow;
determining whether the supply chain event is a task generating event; and
executing the one or more tasks that are defined for the supply chain financial orchestration flow where the supply chain event is a task generating event.

2. The computer-readable medium of claim 1, wherein the configuring the supply chain event as the task generating event further comprises:
defining an agreement associated with the supply chain financial orchestration flow;
defining a documentation and accounting rule for the agreement;
defining the one or more tasks for the documentation and accounting rule;
grouping the one or more tasks into a task group; and
defining the supply chain event as a task generating event for the task group.

3. The computer-readable medium of claim 2, wherein the configuring the supply chain event as the task generating event further comprises defining a forward flow and a return flow for the documentation and accounting rule;
wherein the defining the one or more tasks further comprises defining one or more tasks for the forward flow, and defining one or more tasks for the return flow;
wherein the grouping one or more tasks further comprises grouping one or more tasks for the forward flow and grouping one or more tasks for the return flow; and
wherein the defining the supply chain event as the task generating event further comprises defining the supply chain event as the task generating event for the forward flow and defining the supply chain event as the task generating event for the return flow.

4. The computer-readable medium of claim 3, wherein the configuring the supply chain event as the task generating event further comprises defining a plurality of supply chain financial orchestration flows for the documentation and accounting rule;
wherein the defining the one or more tasks further comprises defining one or more tasks for each supply chain financial orchestration flow;
wherein the grouping one or more tasks further comprises grouping one or more tasks of each supply chain financial orchestration flow into a supply chain financial orchestration flow task group; and
wherein the defining the supply chain event as the task generating event further comprises defining the supply chain event as the task generating event for each supply chain financial orchestration flow task group.

5. The computer-readable medium of claim 1,
wherein the task generating event comprises an ownership change event; and
wherein the ownership change event indicates an ownership change of an item from the first entity to the second entity.

6. The computer-readable medium of claim 5, wherein the one or more tasks comprise one or more financial tasks that change the ownership of the item from the first entity to the second entity.

7. The computer-readable medium of claim 6, wherein at least one of the one or more financial tasks performs accounting based on the ownership change of the item from the first entity to the second entity.

8. The computer-readable medium of claim 5,
wherein the task generating event comprises a documentation creation event;
wherein the documentation creation event indicates a creation of one or more documents; and
wherein the one or more tasks comprise one or more tasks that create one or more documents.

9. The computer-readable medium of claim 1, wherein the supply chain financial orchestration flow comprises an internal transaction,
wherein the first entity comprises a first internal entity; and
wherein the second entity comprises a second internal entity.

10. The computer-readable medium of claim 1, wherein the ownership change event comprises a supplier ownership change event;
wherein the first entity comprises an internal entity; and
wherein the second entity comprises an external entity.

11. A computer-implemented method for processing supply chain events, the computer-implemented method comprising:
defining a supply chain event type;
configuring a supply chain event of the supply chain event type as a task generating event, wherein the task generating event indicates that one or more tasks that are defined for a supply chain financial orchestration flow are to be executed, and wherein the supply chain financial orchestration flow defines a trade relationship between a first entity and a second entity;
receiving a supply chain event associated with the supply chain financial orchestration flow;
determining whether the supply chain event is a task generating event; and
executing one or more tasks that are defined for the supply chain financial orchestration flow where the supply chain event is a task generating event.

12. The computer-implemented method of claim 11, wherein the configuring the supply chain event as the task generating event further comprises:
defining an agreement associated with the supply chain financial orchestration flow;
defining a documentation and accounting rule for the agreement;
defining the one or more tasks for the documentation and accounting rule;
grouping the one or more tasks into a task group; and
defining the supply chain event as a task generating event for the task group.

13. The computer-implemented method of claim 12, wherein the configuring the supply chain event as the task generating event further comprises defining a forward flow and a return flow for the documentation and accounting rule;
wherein the defining the one or more tasks further comprises defining one or more tasks for the forward flow, and defining one or more tasks for the return flow;
wherein the grouping one or more tasks further comprises grouping one or more tasks for the forward flow and grouping one or more tasks for the return flow; and
wherein the defining the supply chain event as the task generating event further comprises defining the supply chain event as the task generating event for the forward flow and defining the supply chain event as the task generating event for the return flow.

14. The computer-implemented method of claim 13, wherein the configuring the supply chain event as the task generating event further comprises defining a plurality of supply chain financial orchestration flows for the documentation and accounting rule;
wherein the defining the one or more tasks further comprises defining one or more tasks for each supply chain financial orchestration flow;
wherein the grouping one or more tasks further comprises grouping one or more tasks of each supply chain financial orchestration flow into a supply chain financial orchestration flow task group; and
wherein the defining the supply chain event as the task generating event further comprises defining the supply chain event as the task generating event for each supply chain financial orchestration flow task group.

15. The computer-implemented method of claim 11,
wherein the task generating event comprises an ownership change event;
wherein the ownership change event indicates an ownership change of an item from the first entity to the second entity; and
wherein the one or more tasks comprise one or more financial tasks that change the ownership of the item from the first entity to the second entity.

16. A system, comprising:
a supply chain event type definition module configured to define a supply chain event type;
a supply chain event configuration module configured to configure a supply chain event of the supply chain event type as a task generating event, wherein the task generating event indicates that one or more tasks that are defined for a supply chain financial orchestration flow are to be executed, and wherein the supply chain financial orchestration flow defines a trade relationship between a first entity and a second entity;
a supply chain event reception module configured to receive a supply chain event associated with the supply chain financial orchestration flow;
a task generating event determination module configured to determine whether the supply chain event is a task generating event; and
a supply chain financial orchestration task module configured to execute one or more tasks that are defined for the supply chain financial orchestration flow where the supply chain event is a task generating event.

17. The system of claim 16, wherein the supply chain event configuration module is further configured to:
define an agreement associated with the supply chain financial orchestration flow;
define a documentation and accounting rule for the agreement;
define one or more tasks for the documentation and accounting rule;
group the one or more tasks into a task group; and
define the supply chain event as a task generating event for the task group.

18. The system of claim 17, wherein the supply chain event configuration module is further configured to:
define a forward flow and a return flow for the documentation and accounting rule;
define one or more tasks for the forward flow, and define one or more tasks for the return flow;
group one or more tasks for the forward flow and group one or more tasks for the return flow; and
define the supply chain event as the task generating event for the forward flow and define the supply chain event as the task generating event for the return flow.

19. The system of claim 18, wherein the supply chain event configuration module is further configured to:
define a plurality of supply chain financial orchestration flows for the documentation and accounting rule;
define one or more tasks for each supply chain financial orchestration flow;
group one or more tasks of each supply chain financial orchestration flow into a supply chain financial orchestration flow task group; and
define the supply chain event as the task generating event for each supply chain financial orchestration flow task group.

20. The system of claim 16, wherein the task generating event comprises an ownership change event;
wherein the ownership change event indicates an ownership change of an item from the first entity to the second entity; and
wherein the one or more tasks comprise one or more financial tasks that change the ownership of the item from the first entity to the second entity.
